(19) United States
(12) Patent Application Publication
(10) Pub. No.: US 2022/0084238 A1
(43) Pub. Date: Mar. 17, 2022

(54) MULTIPLE TRANSPARENT OBJECTS 3D DETECTION

(71) Applicant: FANUC CORPORATION, Yamanashi (JP)

(72) Inventors: Te Tang, Fremont, CA (US); Tetsuaki Kato, Fremont, CA (US)

(21) Appl. No.: 17/018,141

(22) Filed: Sep. 11, 2020

(51) Int. Cl. G06T 7/73; G06K 9/00; G06T 7/11; G06T 11/00; G06K 9/46

(52) U.S. Cl. CPC G06T 7/73; G06K 9/00208; G06K 9/00664; G06T 7/11; G06T 2210/12; G06K 9/46; G06T 2207/20132; G06T 2207/10024; G06T 2207/20084; G06T 11/001

(57) ABSTRACT

A system and method for obtaining a 3D pose of objects, such as transparent objects, in a group of objects to allow a robot to pick up the objects. The method includes obtaining a 2D red-green-blue (RGB) color image of the objects using a camera, and generating a segmentation image of the RGB images by performing an image segmentation process using a deep learning convolutional neural network that extracts features from the RGB image and assigns a label to pixels in the segmentation image so that objects in the segmentation image have the same label. The method also includes separating the segmentation image into a plurality of cropped images where each cropped image includes one of the objects, estimating the 3D pose of each object in each cropped image, and combining the 3D poses into a single pose image.

### BACKGROUND

### Field

This disclosure relates generally to a system and method for obtaining a 3D pose of an object and, more particularly, to a robot system that obtains a 3D pose of an object that is part of a group of objects, where the system obtains an RGB image of the objects, segments the image using image segmentation, crops out the segmentation images of the objects and uses a learned-based neural network to obtain the 3D pose of each object in the segmentation images.

### Discussion of the Related Art

Robots perform a multitude of tasks including pick and place operations, where the robot picks up and moves objects from one location, such as a collection bin, to another location, such as a conveyor belt, where the location and orientation of the objects, known as the object's 3D pose, in the bin are slightly different. Thus, in order for the robot to effectively pick up an object, the robot often needs to know the 3D pose of the object. In order to identify the 3D pose of an object being picked up from a bin, some robot systems employ a 3D camera that generates 2D red-green-blue (RGB) color images of the bin and 2D gray scale depth map images of the bin, where each pixel in the depth map image has a value that defines the distance from the camera to a particular object, i.e., the closer the pixel is to the object the lower its value. The depth map image identifies distance measurements to points in a point cloud in the field-of-view of the camera, where a point cloud is a collection of data points that is defined by a certain coordinate system and each point has an x, y and z value. However, if the object being picked up by the robot is transparent, light is not accurately reflected from a surface of the object and the point cloud generated by the camera is not effective and the depth image is not reliable, and thus the object cannot be reliably identified to be picked up.

U.S. patent application Ser. No. 16/839,274, titled 3D Pose Estimation by a 2D camera, filed Apr. 3, 2020, assigned to the assignee of this application and herein incorporated by reference, discloses a robot system for obtaining a 3D pose of an object using 2D images from a 2D camera and a learned-based neural network that is able to identify the 3D pose of a transparent object being picked up. The neural network extracts a plurality of features on the object from the 2D images and generates a heatmap for each of the extracted features that identify the probability of a location of a feature point on the object by a color representation. The method provides a feature point image that includes the feature points from the heatmaps on the 2D images, and estimates the 3D pose of the object by comparing the feature point image and a 3D virtual CAD model of the object. In other words, an optimization algorithm is employed to optimally rotate and translate a CAD model so that projected feature points match in the model with predicted feature points in the image.

As mentioned, the '274 robotic system predicts multiple feature points on the images of the object being picked up by the robot. However, if the robot is selectively picking up an object from a group of objects, such as objects in a bin, there would multiple objects in the image and each object would have multiple predicted features. Therefore, when the CAD model is rotated its projected feature points may match the predicted feature points on different objects, thus preventing the process from reliably identifying the pose of a single object.

### SUMMARY

The following discussion discloses and describes a system and method for obtaining a 3D pose of objects to allow a robot to pick up the objects. The method includes obtaining a 2D red-green-blue (RGB) color image of the objects using a camera, and generating a segmentation image of the RGB images by performing an image segmentation process using a deep learning convolutional neural network that extracts features from the RGB image and assigns a label to pixels in the segmentation image so that objects in the segmentation image have the same label. The method also includes separating the segmentation image into a plurality of cropped images where each cropped image includes one of the objects, estimating the 3D pose of each object in each cropped image, and combining the 3D poses into a single pose image. The steps of obtaining a color image, generating a segmentation image, separating the segmentation image, estimating a 3D pose of each object and combining the 3D poses are performed each time an object is picked up from the group of objects by the robot.

Additional features of the disclosure will become apparent from the following description and appended claims, taken in conjunction with the accompanying drawings.

### BRIEF DESCRIPTION OF THE DRAWINGS

FIG. 1 is an illustration of a robot system including a robot picking up objects out of a bin;

FIG. 2 is a schematic block diagram of a bin picking system for picking up the objects from the bin in the robot system shown in FIG. 1;

FIG. 3 is a schematic block diagram of a segmentation module separated from the system shown in FIG. 2;

FIG. 4 is a flow-type diagram showing a learned-based neural network process for using a trained neural network for estimating a 3D pose of an object using a 2D segmentation image of the object and a neural network;

FIG. 5 is an illustration depicting a perspective-n-point (PnP) process for determining a 3D pose estimation of the object in the process shown in FIG. 4; and

FIG. 6 is an illustration of a segmented image including multiple categories each having multiple objects.

### DETAILED DESCRIPTION OF THE EMBODIMENTS

The following discussion of the embodiments of the disclosure directed to a robot system that obtains a 3D pose of an object that is in a group of transparent objects, where the system obtains an RGB image of the objects, segments the image using image segmentation, crops out the segmented images of the objects and uses a learned-based neural network to obtain the 3D pose of the segmented objects is merely exemplary in nature, and is in no way intended to limit the invention or its applications or uses. For example, the system and method have application for determining the position and orientation of a transparent object that is in a group of transparent objects. However, the system and method may have other applications.

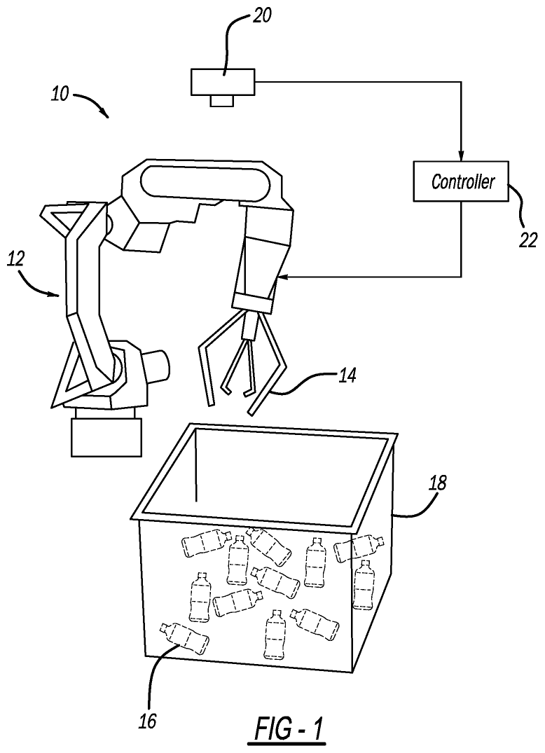

FIG. 1 is an illustration of a robot system 10 including a robot 12 having an end-effector 14 that is shown individually picking up objects 16, for example, transparent bottles, from a bin 18. The system 10 is intended to represent any type of robot system that can benefit from the discussion herein, where the robot 12 can be any robot suitable for that purpose. A camera 20 is positioned to take top down images of the bin 18 and provide them to a robot controller 22 that controls the movement of the robot 12. Because the objects 16 can be transparent, the controller 22 cannot rely on a depth map image to identify the location of the objects 16 in the bin 18. Therefore only RGB images are used from the camera 20 and as such the camera 20 can be a 2D or 3D camera.

In order for the robot 12 to effectively grasp and pick up the objects 16 it needs to be able to position the end-effector 14 at the proper location and orientation before it grabs the object 16. As will be discussed in detail below, the robot controller 22 employs an algorithm that allows the robot 12 to pick up the objects 16 without having to rely on an accurate depth map image. More specifically, the algorithm performs an image segmentation process using the different colors of the pixels in an RGB image from the camera 20. Image segmentation is a process of assigning a label to every pixel in an image such that pixels with the same label share certain characteristics. Thus, the segmentation process predicts which pixel belongs to which of the objects 16.

Modern image segmentation techniques may employ deep learning technology. Deep learning is a particular type of machine learning that provides greater learning performance by representing a certain real-world environment as a hierarchy of increasing complex concepts. Deep learning typically employs a software structure comprising several layers of neural networks that perform nonlinear processing, where each successive layer receives an output from the previous layer. Generally, the layers include an input layer that receives raw data from a sensor, a number of hidden layers that extract abstract features from the data, and an output layer that identifies a certain thing based on the feature extraction from the hidden layers. The neural networks include neurons or nodes that each has a “weight” that is multiplied by the input to the node to obtain a probability of whether something is correct. More specifically, each of the nodes has a weight that is a floating point number that is multiplied with the input to the node to generate an output for that node that is some proportion of the input. The weights are initially “trained” or set by causing the neural networks to analyze a set of known data under supervised processing and through minimizing a cost function to allow the network to obtain the highest probability of a correct output.

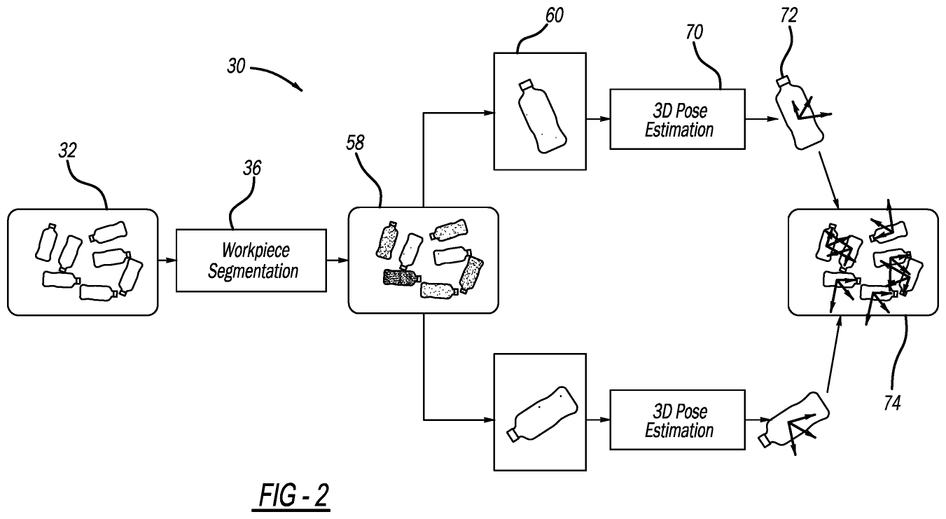

FIG. 2 is a schematic block diagram of a bin picking system 30 that is part of the controller 22 in the robot system 10 that operates to pick up the objects 16 out of the bin 18. The system 30 receives a 2D RGB image 32 of a top view of the bin 18 from the camera 20 where the objects 16 are shown in the image 32. The image 32 is provided to a segmentation module 36 that preforms an image segmentation process, where each pixel is assigned a certain label and where the pixels associated with the same object 16 have the same label.

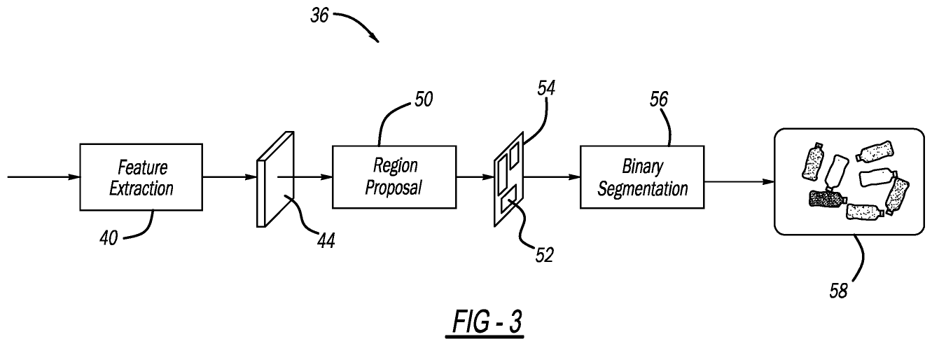

FIG. 3 is a schematic block diagram of the module 36 separated from the system 30. The RGB image 32 is provided to a feature extraction module 40 that performs a filtering process that extracts important features from the image 32, which removes background and noise. For example, the module 40 may include learned-based neural networks that extract gradients, edges, contours, elementary shapes, etc. from the image 32, where the module 40 provides an extracted features image 44 of the RGB image 32 in a known manner. The feature image 44 is provided to a region proposal module 50 that analyzes, using neural networks, the identified features in the image 44 to determine the location of the objects 16 in the image 44. Particularly, the module 50 includes trained neural networks providing a number of bounding boxes, such as 50 to 100 boxes, of different sizes, i.e., boxes having various lengths and widths, that are used to identify the probability that an object 16 exists at a certain location in the image 44. In this embodiment, the bounding boxes are all vertical boxes, which helps reduce the complexity of the module 50. The region proposal module 50 employs a sliding search window template, well known to those skilled in the art, where a search window including all of the bounding boxes is moved over the feature image 44, for example, from a top left of the image 44 to a bottom right of the image 44, to look for features that identify the probable existence of one of the objects 16.

The sliding window search produces a bounding box image 54 including a number of bounding boxes 52 that each surrounds a predicted object in the image 44, where the number of bounding boxes 52 in the image 54 will be reduced each time the robot 12 removes one of the objects 16 from the bin 18. The module 50 parameterizes a center location (x, y), width (w) and height (h) of each box 52 and provides a prediction confidence value between 0% and 100% that an object 16 exists in the box 52. The image 54 is provided to a binary segmentation module 56 that estimates, using a neural network, whether a pixel belongs to the object 16 in each of the bounding boxes 52 to eliminate background pixels in the box 52 that are not part of the object 16. The remaining pixels in the image 54 in each of the boxes 52 are assigned a value for a particular object 16 so that a 2D segmentation image 58 is generated that identifies the objects 16 by different indicia, such as color. The image segmentation process as described is thus a modified form of a deep learning mask R-CNN (convolutional neural network). The segmented objects in the image 58 are then cropped to separate each of the identified objects 16 in the image 58 as cropped images 60 having only one of the objects 16.

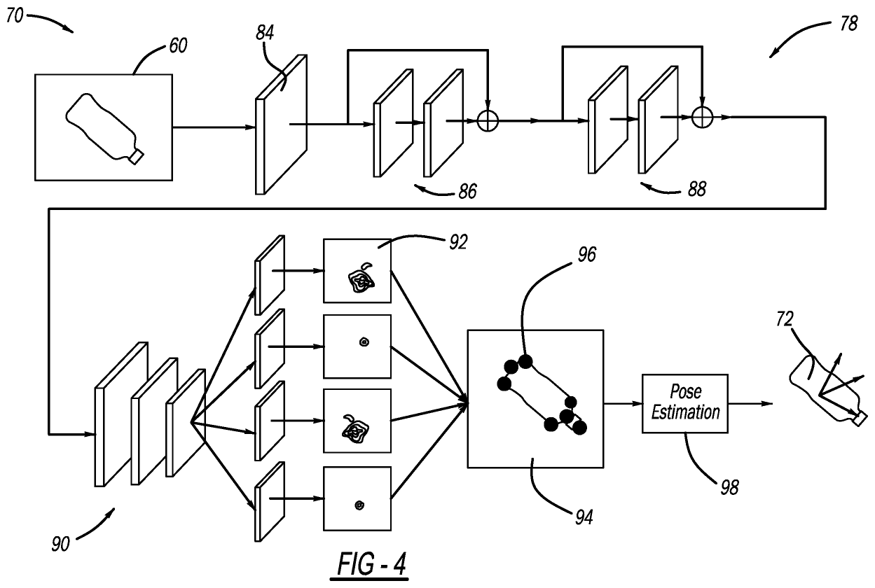

Each of the cropped images 60 is then sent to a separate 3D pose estimation module 70 that performs the 3D pose estimation of the object 16 in that image 60 to obtain an estimated 3D pose 72 in the same manner, for example, as in the '274 application. FIG. 4 is a flow-type diagram 80 showing an algorithm operating in the module 70 that employs a learned-based neural network 78 using a trained neural network to estimate the 3D pose of the object 16 in the particular cropped image 60. The image 60 is provided to an input layer 84 and multiple consecutive residual block layers 86 and 88 that include a feed-forward loop in the neural network 78 operating in the AI software in the controller 22 that provide feature extraction, such as gradients, edges, contours, etc., of possible feature points on the object 16 in the image 60 using a filtering process. The images including the extracted features are provided to multiple consecutive convolutional layers 90 in the neural network 78 that define the possible feature points obtained from the extracted features as a series of heatmaps 92, one for each of the feature points, that illustrate the likelihood of where the feature point exists on the object 16 based on color in the heatmap 92. An image 94 is generated using the image 60 of the object 16 that includes feature points 96 for all of the feature points from all of the heatmaps 92, where each feature point 96 is assigned a confidence value based on the color of the heatmap 92 for that feature point, and where those feature points 96 that do not have a confidence value above a certain threshold are not used.

The image 94 is then compared to a nominal or virtual 3D CAD model of the object 16 that has the same feature points in a pose estimation processor 98 to provide the estimated 3D pose 72 of the object 14. One suitable algorithm for comparing the image 94 to the CAD model is known in the art as perspective-n-point (PnP). Generally, the PnP process estimates the pose of an object with respect to a calibrated camera given a set of n 3D points of the object in the world coordinate frame and their corresponding 2D projections in an image from the camera 20. The pose includes six degrees-of-freedom (DOF) that are made up of the rotation (roll, pitch and yaw) and 3D translation of the object with respect to the camera coordinate frame.

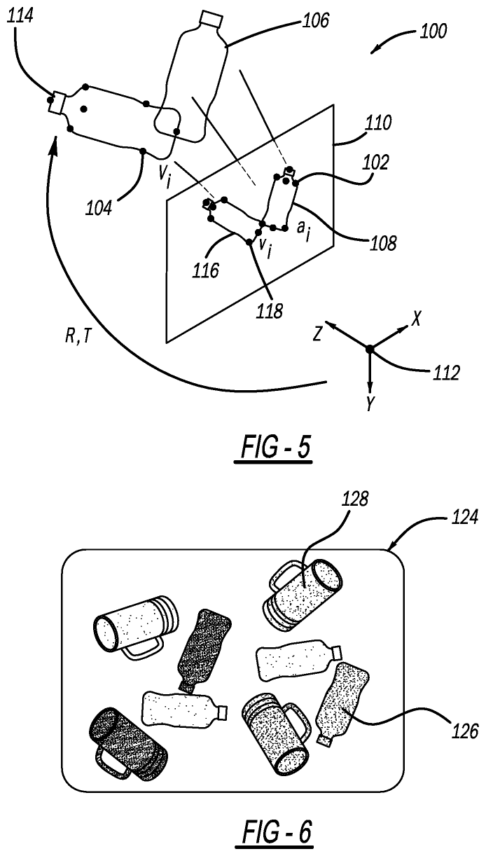

FIG. 5 is an illustration 100 of how the PnP process may be implemented in this example to obtain the 3D pose of the object 16. The illustration 100 shows a 3D object 106, representing the object 16, at a ground truth or real location. The object 106 is observed by a camera 112, representing the camera 20, and projected as a 2D object image 108 on a 2D image plane 110, where the object image 108 represents the image 94 and where points 102 on the image 108 are feature points predicted by the neural network 78, representing the points 96. The illustration 100 also shows a virtual 3D CAD model 114 of the object 16 having feature points 104 at the same location as the feature points 96 that is randomly placed in front of the camera 112 and is projected as a 2D model image 116 on the image plane 110 also including projected feature points 118. The CAD model 114 is rotated and translated in front of the camera 112, which rotates and translates the model image 116 in an attempt to minimize the distance between each of the feature points 118 on the model image 116 and the corresponding feature points 102 on the object image 108, i.e., align the images 116 and 108. Once the model image 116 is aligned with the object image 108 as best as possible, the pose of the CAD model 114 with respect to the camera 112 is the estimated 3D pose 72 of the object 16.

This analysis is depicted by equation (1) for one of the corresponding feature points between the images 108 and 116, where equation (1) is used for all of the feature points of the images 108 and 116.

$${min}_{( R , T )} {\sum }_{i = 1}^{I} {( {v}_{i} - {a}_{i} )}^{′} ( {v}_{i} - {a}_{i} ) , \\ s . t . {v}_{i} = project ( R {V}_{i} + T ) , ∀ i \qquad ( 1 )$$

where Vᵢ is one of the feature points 104 on the CAD model 114, vᵢ is the corresponding projected feature point 102 in the model image 116, aᵢ is one of the feature points 102 on the object image 108, R is the rotation and T is the translation of the CAD model 114 both with respect to the camera 112, symbol ′ is the vector transpose, and V refers to any feature point with index 1. By solving equation (1) with an optimization solver, the optimal rotation and translation can be calculated, thus providing the estimation of the 3D pose 72 of the object 16.

All of the 3D poses 72 are combined into a single image 74, and the robot 12 selects one of the objects 16 to pick up. Once the object 16 is picked up and moved by the robot 12, the camera 20 will take new images of the bin 18 to pick up the next object 16. This process is continued until all of the objects 16 have been picked up.

The discussion above talks about identifying the 3D pose of objects in a group of objects having the same type or category of objects, i.e., transparent bottles. However, the process described above has application identifying the 3D pose of objects in a group of objects having different types or category of objects. This is illustrated by a segmented image 124 shown in FIG. 6 including segmented objects 126, i.e., bottles, of one category and segmented objects 128, i.e., mugs, of another category.

As will be well understood by those skilled in the art, the several and various steps and processes discussed herein to describe the disclosure may be referring to operations performed by a computer, a processor or other electronic calculating device that manipulate and/or transform data using electrical phenomenon. Those computers and electronic devices may employ various volatile and/or non-volatile memories including non-transitory computer-readable medium with an executable program stored thereon including various code or executable instructions able to be performed by the computer or processor, where the memory and/or computer-readable medium may include all forms and types of memory and other computer-readable media.

The foregoing discussion discloses and describes merely exemplary embodiments of the present disclosure. One skilled in the art will readily recognize from such discussion and from the accompanying drawings and claims that various changes, modifications and variations can be made therein without departing from the spirit and scope of the disclosure as defined in the following claims.

1. A method for obtaining a 3D pose of objects in a group of objects, said method comprising:
obtaining a 2D red-green-blue (RGB) color image of the objects using a camera;
generating a 2D segmentation image of the RGB image by performing an image segmentation process that extracts features from the RGB image and assigns a label to pixels in the segmentation image so that the pixels in each object in the segmentation image have the same label and the pixels of different objects in the segmentation image have different labels including objects that have a same or similar shape;
separating the segmentation image into a plurality of 2D cropped images where each cropped image includes one of the objects;
estimating the 3D pose of each object in each cropped image that includes extracting a plurality of features on the object from the 2D image; and
combining the 3D poses into a single pose image.

2. The method according to claim 1 wherein generating a segmentation image includes using a deep learning mask R-CNN (convolutional neural network).

3. The method according to claim 1 wherein generating a segmentation image includes providing a plurality of bounding boxes, aligning the bounding boxes to the extracted features and providing a bounding box image that includes bounding boxes surrounding the objects.

4. The method according to claim 3 wherein generating a segmentation image includes determining a probability that an object exists in each bounding box.

5. The method according to claim 3 wherein generating a segmentation image includes removing pixels from each bounding box in the bounding box image that are not associated with an object.

6. (canceled)

7. The method according to claim 1 wherein estimating the 3D pose of each object includes using a neural network for extracting the features, generating a heatmap for each of the extracted features that identify a probability of a location of a feature point on the object, providing a feature point image that combines the feature points from the heatmaps and the 2D image, and estimating the 3D pose of the object using the feature point image.

8. The method according to claim 7 wherein estimating the 3D pose of each object includes comparing the feature point image to a 3D virtual model of the object.

9. The method according to claim 8 wherein estimating the 3D pose of each object includes using a perspective-n-point algorithm.

10. The method according to claim 1 wherein the objects are transparent.

11. The method according to claim 1 wherein the group of objects includes objects having different shapes.

12. The method according to claim 1 wherein the method is employed in a robot system and the objects are being picked up by a robot.

13. A method for obtaining a 3D pose of transparent objects in a group of transparent objects to allow a robot to pick up the objects, said method comprising:
obtaining a 2D red-green-blue (RGB) color image of the objects using a camera;
generating a segmentation image of the RGB image by performing an image segmentation process using a deep learning convolutional neural network that extracts features from the RGB image and assigns a label to pixels in the segmentation image so that the pixels in each object in the segmentation image have the same label and the pixels of different objects in the segmentation image have different labels including objects that have a same or similar shape;
separating the segmentation image into a plurality of cropped images where each cropped image includes one of the objects;
estimating the 3D pose of each object in each cropped image that includes extracting a plurality of features on the object from the 2D image; and
combining the 3D poses into a single pose image, wherein obtaining a color image, generating a segmentation image, separating the segmentation image, estimating a 3D pose of each object and combining the 3D poses are performed each time an object is picked up from the group of objects by the robot.

14. The method according to claim 13 wherein generating a segmentation image includes providing a plurality of vertically aligned bounding boxes having the same orientation, aligning the bounding boxes to the extracted features using a sliding window template, providing a bounding box image that includes bounding boxes surrounding the objects, determining a probability that an object exists in each bounding box, removing pixels from each bounding box that are not associated with an object and identifying a center pixel of each object in the bounding boxes.

15. The method according to claim 13 wherein estimating the 3D pose of each object includes using a neural network for extracting the features, generating a heatmap for each of the extracted features that identify a probability of a location of a feature point on the object, providing a feature point image that combines the feature points from the heatmaps and the 2D image, and estimating the 3D pose of the object using the feature point image by comparing the feature point image to a 3D virtual model of the object.

16. The method according to claim 15 wherein estimating the 3D pose of each object includes using a perspective-n-point algorithm.

17. The method according to claim 13 wherein the camera is a 2D camera or a 3D camera.

18. A system for obtaining a 3D pose of objects in a group of objects, said system comprising:
a camera that provides a 2D red-green-blue (RGB) color image of the objects;
a deep learning convolutional neural network that generates a segmentation image of the objects by performing an image segmentation process that extracts features from the RGB image and assigns a label to pixels in the segmentation image so that the pixels in each object in the segmentation image have the same label and the pixels of different objects in the segmentation image have different labels including objects that have a same or similar shape;
means for separating the segmentation image into a plurality of cropped images where each cropped image includes one of the objects;
means for estimating the 3D pose of each object in each cropped image that includes extracting a plurality of features on the object from the 2D image; and
means for combining the 3D poses into a single pose image.

19. The system according to claim 18 wherein the deep learning neural network provides a plurality of vertically aligned bounding boxes having the same orientation, aligns the bounding boxes to the extracted features using a sliding window template, provides a bounding box image that includes bounding boxes surrounding the objects, determines a probability that an object exists in each bounding box, removes pixels from each bounding box that are not associated with an object and identifies a center pixel of each object in the bounding boxes.

20. The system according to claim 18 wherein the means for estimating the 3D pose of each object uses a neural network, generates a heatmap for each of the extracted features that identify a probability of a location of a feature point on the object, provides a feature point image that combines the feature points from the heatmaps and the 2D image, and estimates the 3D pose of the object using the feature point image by comparing the feature point image to a 3D virtual model of the object.

21. The system according to claim 20 wherein the means for estimating the 3D pose of each object uses a perspective-n-point algorithm.
